(19) United States
(12) Patent Application Publication
(10) Pub. No.: US 2007/0264130 A1
(43) Pub. Date: Nov. 15, 2007

(54) Infusion Pumps and Methods for Use

(75) Inventor: Scott Mallett, Coto De Caza, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: PHLUID, INC.

(21) Appl. No.: 11/744,819

(22) Filed: May 4, 2007

Related U.S. Application Data
(63) Continuation of application No. 11/343,817, filed on Jan. 31, 2006.
(63) Continuation of application No. 11/342,015, filed on Jan. 27, 2006.

(51) Int. Cl. G01L 7/16; F04B 49/00

(52) U.S. Cl. 417/38; 73/744; 92/247

(57) ABSTRACT

Infusion pump device and methods allow for determination of volumes and flow rates of fluids delivered. Determination is accomplished without direct measurement of either the fluid or flow rate, but by measuring pressure differentials of abutting chambers. The ideal gas law is used to calculate of the volumes and flow rates of the fluids dispended by the devices and via the methods disclosed herein.

### RELATED APPLICATION

This application is a continuation of and claims the benefit of and priority to U.S. Utility application Ser. Nos. 11/343,817 filed Jan. 31, 2006, and 11/342,015 filed on Jan. 27, 2006 the contents of which are expressly incorporated by reference herein in their entirety.

### BACKGROUND

This disclosure relates to an apparatus and associated methods for dispensing fluids at known, measurable rates. More specifically, the present disclosure relates to pump-type devices that deliver fluids without direct measurement of the flow rate of the flow material.

Many variations of pumps, particularly infusion pumps are known. However, the volumes of materials pumped by pumps has historically been difficult to measure in real-time. Rather, measurements are made at some point before or after the fact. Because the measurements are made after the fact, there is lag in the measured delivery rate or volume and adjustments to the pumping volume. Indeed, as related to medical devices, prior to the present disclosure there were no devices that were able to measure flow rate and the delivery volume in real time.

Moreover, in many of these systems, the ability to measure the flow rate or volume delivered without physically contacting the delivery material is desired. Many flow materials are provided in sterile accoutrements, which are directly connected to sterile delivery mechanisms. Thus, the flow materials cannot be measured or otherwise contacted to determine volume prior to delivery, whereby either the sterility of the system is compromised or the flow rate must be estimated, not measured.

Sterile fluid are generally packaged or segregated after ensure the vessels holding them are also sterile. Traditionally, to determine the volume delivered the weight of the vessel and fluid is measured before and after, but not during the actual process of dispensing the fluid. In fact, prior to the present disclosure no cost-effective solution existed that measured flow in real-time.

The present inventors have discovered a novel method of determining volume and therefore flow rate of a fluid in about real-time using the ideal gas law. The apparatuses and methods disclosed herein measure flow indirectly, making them desirable in the medical community and other industries where maintenance of sterility is problematic, i.e., where the flow measurement hardware cannot wetted by the fluid.

### SUMMARY

Infusion pump-type devices and methods allow for determination of volumes and flow rates of fluids delivered. The devices are multi-chambered, he chambers having known volumes. Indirect measurement of flow is effected by determining changes to chambers nearby a chamber holding a flow material. Determination is accomplished without direct measurement of either the fluid or flow rate, but by measuring pressure differentials of abutting chambers. The ideal gas law is used to calculate of the volumes and flow rates of the fluids dispended by the devices and via the methods disclosed herein.

According to a feature of the present disclosure, a device is disclosed comprising at least one first chamber, each first chamber having a pressure sensor to determine pressure changes in each first chamber; at least one second chamber, each second chamber having a pressure sensor to determine pressure changes in each second chamber; at least one third chamber having a dispensing port; a device for transferring gas from each first chamber to one second chamber; a movable boundary between the second chamber and the third chamber; and a processor.

Also according to a feature of the present disclosure a method is disclosed comprising providing at least one first chamber holding a gas, providing at least one second chamber holding a gas, providing at least one third chamber holding a fluid to be delivered, measuring a first pressure in each first chamber, measuring a first pressure in each second chamber, transferring gas from at least one first chamber to at least one second chamber to measure the volume of a second chamber, measuring a second pressure in each first chamber, measuring a second pressure in each second chamber, and calculating the dispensed volume of fluid from the third chamber based upon the first and second pressures sensed.

Finally disclosed according to a feature of the present disclosure is a method comprising calculating the pressure difference in a first chamber and a second chamber after a gas has been transferred to calculate the volume of a third chamber by: (a) determining the volume of the first chamber and the total volume of the second and third chambers, (b) measuring the pressures of both the first chamber and second chamber prior to transfer of the gas from the first chamber to the second chamber, (c) transferring an aliquot of gas from the first chamber to the second chamber, and (d) measuring the pressures of both the first chamber and the second chamber after the gas is transferred; calculating the volume of the second chamber from the pressure data collected prior to the transfer of gas and the pressure data after the transfer of the gas using the ideal gas law; calculating the volume of the third chamber by subtracting the volume of the second chamber from the total volume of the second and third chambers to determine the volume of fluid delivered.

### DRAWINGS

The above-mentioned features and objects of the present disclosure will become more apparent with reference to the following description taken in conjunction with the accompanying drawings wherein like reference numerals denote like elements and in which:

FIGS. 1A and 1B are graphs of an exemplary embodiments of pressure versus time for a first chamber and a second chamber, respectively;

FIGS. 2A, 2B, and 2C are graphs of an exemplary embodiment of volume versus time for a first, second, and third chamber, respectively;

FIG. 3 is a perspective view of an embodiment of a syringe-type device of the present disclosure;

FIG. 4 is a perspective view of the modules of an embodiment of a syringe-type device of the present disclosure;

FIG. 4A is a perspective view of an embodiment of a hardware module of a syringe-type device of the present disclosure;

FIG. 5 is a perspective view of an embodiment of a syringe-type device of the present disclosure;

FIG. 6 is a perspective view of an embodiment of an IV-type device of the present disclosure;

FIG. 7 is a flow diagram of an embodiment of a method of the present disclosure; and

FIG. 8 is a block diagram of the interrelationship of the hardware components of the devices of present disclosure.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

According to the present disclosure, a “chamber” shall be defined as a space having a volume into which a gas or fluid may be disposed.

Generally, the present disclosure is based on the principle of the ideal gas law. The ideal gas law is:
PV=nRT
where P is pressure, V is volume, n is the number of molecules, R is the gas constant, and T is the temperature. To measure the flow rate of a fluid being dispensed without directly measuring the pressure, volume, or temperature of the chamber holding the flow material requires determining, at any given point, the volume of the chamber holding the fluid and the time elapsed.

The inventors have discovered that by using at least three chambers in a system, the volume of the chamber holding fluid may be determined in nearly real-time (as fast as the sensors can accurately register and the time needed to make the necessary computations from the sensors). Additionally, the volume may be determined without contacting the chamber holding the fluid, providing a method for accurately determining both volume and flow rate of fluids without affecting sterility of the fluid and the chamber holding it.

The volume of a chamber holding a fluid in a system of at least three chambers may be calculated with the ideal gas law as a system of equations. The following set of equations is generally adaptable to any system of three or more chambers. For the purposes of this disclosure, let:
C₁ represent at least one chamber having a known volume, V₁, and a pressure sensor;
C₂ represent at least one chamber having a volume, V₂, and a pressure sensor; and
C₃ represent at least one chamber having a fluid to be delivered with a volume, V₃.
   The volume of chambers C₂ and C₃ is a known constant, V₂₃. Moreover, the volume of chamber C, is fixed and denoted as V₁. Thus, the total volume of V₁+V₂₃ is known. Additionally, between C₂ and C₃ is a movable, flexible, or compressible barrier that allows C₂ to increase in volume while C₃ decreases in volume during the delivery of the fluid. The inventors of the present disclosure expressly contemplate that C₁, C₂, and C₃ are merely chambers in the abstract and may in fact comprise one or more chambers dedicated to a single task. For example, two or more C₁ chambers may be disposed about C₂ to provide pressurized gas to C₂, etc. The inventors of the present disclosure expressly recognize the present systems of equations may be easily adapted to devices having greater than three chambers.

If the volume of V₂ is calculated, the volume of V₃ may be determined by solving the equation:
V₃=V₂₃−V₂
because the volume of V₂₃ is constant.

To calculate the volume of V₂, the ideal gas is used for chambers C₁ and C₂. Generally:

$$\frac{PV}{RT} = n$$

Thus, for each chamber C₁ and C₂:

$$\frac{{P}_{1} {V}_{1}}{{RT}_{1}} = {n}_{1} and \frac{{P}_{2} {V}_{2}}{{RT}_{2}} = {n}_{2}$$

The mass of gas in C, and C₂ is fixed. According to embodiments, the mass of gas in C₁ and C₂ may be periodically adjusted. By adding the mass of C₁ to the mass of C₂, the following results:

$$\frac{{P}_{1} {V}_{1}}{{RT}_{1}} + \frac{{P}_{2} {V}_{2}}{{RT}_{1}} = {n}_{1} + {n}_{2} = {n}_{12}$$

The volume of chamber C₂ is unknown because of the barrier between C₂ and C₃ and the unknown volume of fluid in the device initially. To measure V₂, transfer of material from C₁ to C₂ is effected and the resulting pressures P₁ and P₂ in each of C₁ and C₂ respectively measured. Thus, the state of C₁ and C₂ after the material has been transferred is described by:

$$\frac{{P}_{1}^{′} {V}_{1}}{{RT}_{1}} + \frac{{P}_{2}^{′} {V}_{2}}{{RT}_{2}} = {n}_{12}$$

where P′₁ and P′₂ are the respective changes in pressure of C₁ and C₂ respectively as measured by the pressure sensor disposed in each chamber. Artisans will appreciate that n₁₂ remains constant as the overall amount of material held within C₁ and C₂ doesn't change in aggregate, only the respective amount held in each changes in the transfer step. Therefore:

$$\frac{{P}_{1}^{′} {V}_{1}}{{RT}_{1}} + \frac{{P}_{2}^{′} {V}_{2}}{{RT}_{2}} = \frac{{P}_{1} {V}_{1}}{{RT}_{1}} + \frac{{P}_{2} {V}_{2}}{{RT}_{1}}$$

For the sake of simplicity, assume that there is no appreciable change in temperature as the material is moved from C₁ to C₂. Thus, T₁=T₂ and
P₁V₁+P₂V₂=P′₁V₁+P′₂V₂
solving for V₂ yields the following equation:

$${V}_{2} = {V}_{1} \frac{{P}_{1} - {P}_{1}^{′}}{{P}_{2}^{′} - {P}_{2}} = {V}_{1} \frac{Δ {P}_{1}}{Δ {P}_{2}}$$

where V₃, is an initial volume of C₃ and V_{3g} is a final volume of C₃.

By storing the initial pressure readings and taking an updated pressure reading from both chambers C₁ and C₂ over time after fluid has flowed from C₃ whereby the volume of C₂ has increased and the volume of C₃ has decreased, the new volume of C₂ may be calculated as shown above. Consequently, the volume of C₃ is determined by computing:
V₃=V₂₃−V₂
because both V₂₃ and V₂ are known. Consequently, flow rate of the fluid may be calculated generally by:

$$\frac{{V}_{{3}_{i}} - {V}_{{3}_{f}}}{t}$$

where V₃_{_{f}} is the volume of C₃ at a starting time i, V₃_{_{f}} is the volume of C₃ at an ending time f, and t is the elapsed time between i and f.

According to embodiments, to increase accuracy, temperature may be factored into the equation solving for V2 as follows:

$${V}_{1} \frac{{P}_{1} {T}_{1}^{′}}{{P}_{2}^{′} {T}_{2}} - \frac{{P}_{1}^{′} {T}_{1}}{{P}_{2} {T}_{2}^{′}}$$

where T₁ and T₂ are temperatures in an initial state and T₁ and T₂ are temperatures of C₁ and C₂ after mass has been transferred from C₁ to C₂.

Optionally, according to embodiments, an initialization step is performed. The initialization step is designed to accurately determine the volume of fluid prior to dispensing the fluid from C₃. Initialization is accomplished by purging the gas in C₂ followed by recharging the volume of C₂ from C₁ while preventing fluid flow from C₃. The purge/recharge process produces a large ΔP. The larger the value of ΔP, the more accurate the determination of V₂, and consequently the accuracy for the measurement of the volume of fluid within C₃ may be more accurately determined initially. As error tends to be more prevalent at the small ΔP values observed during normal operation, the initialization provides a more accurate baseline comparison model over time due to reducing the level of error inherent in pressure measurement.

According to embodiments, various configurations may have multiple first chambers, second chambers, or third chambers. The inventors expressly contemplate systems having C₁, C₂, and C₃ running in multiple iterations in parallel. Also expressly contemplated, are having greater than three chambers. For example, if two C₁ chambers were in gas communication with a single C₂ chamber, the equations above would be modified by adding an additional first chamber. The total amount of gas in both the first chambers may be described as:
n₁ₐ+n_{1b}=n₁
by the substituting n₁ by the equation above it follows that (assuming constant temperature):
P₁ₐV₁ₐ+P_{1b}V_{1b}+P₂V₂=P′₁ₐV₁ₐ+P′_{1b}V_{1b}+P′₂V₂
therefore,

$${V}_{2} = \frac{{V}_{1 a} ( {P}_{1 a} - {P}_{1 a} ) + {V}_{1 b} ( {P}_{1 b} - {P}_{1 b}^{′} )}{( {P}_{2}^{′} - {P}_{2} )}$$

simplifies to:

$${V}_{2} = \frac{{V}_{1 a} Δ {P}_{1 a} + {V}_{1 b} Δ {P}_{1 b}}{Δ {P}_{2}} .$$

Naturally, temperature is easy to add back into the equation, and artisans will readily know and understand how do so.

Also according to embodiments, flow rate is controllable by varying the variable n₂. Because flow rate is proportional to pressure in C₂, C₂ can be vented. By controlling the amount of time together with a gas flow restrictor between C₁ and C₂, for example, n₂ may be adjusted to adjust the associated flow rates.

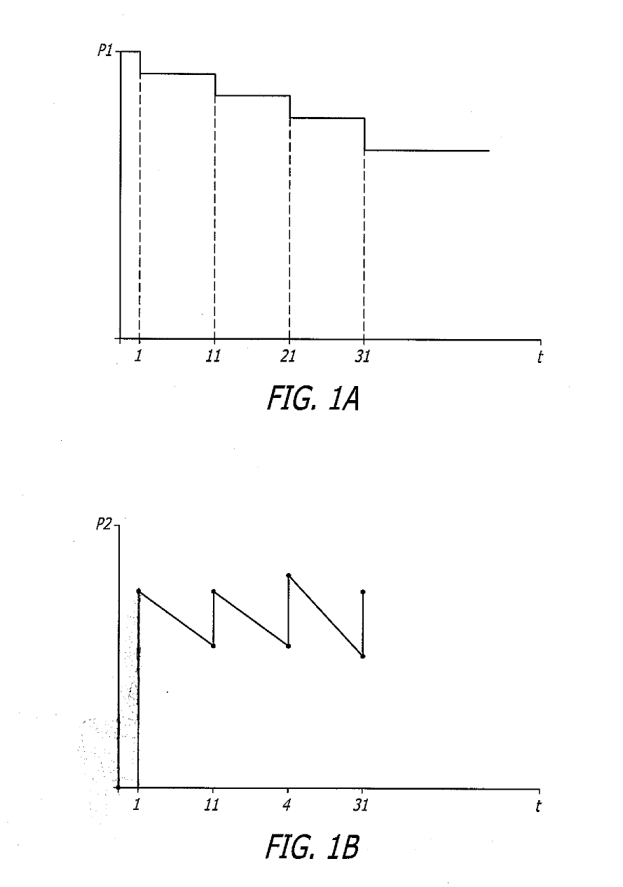

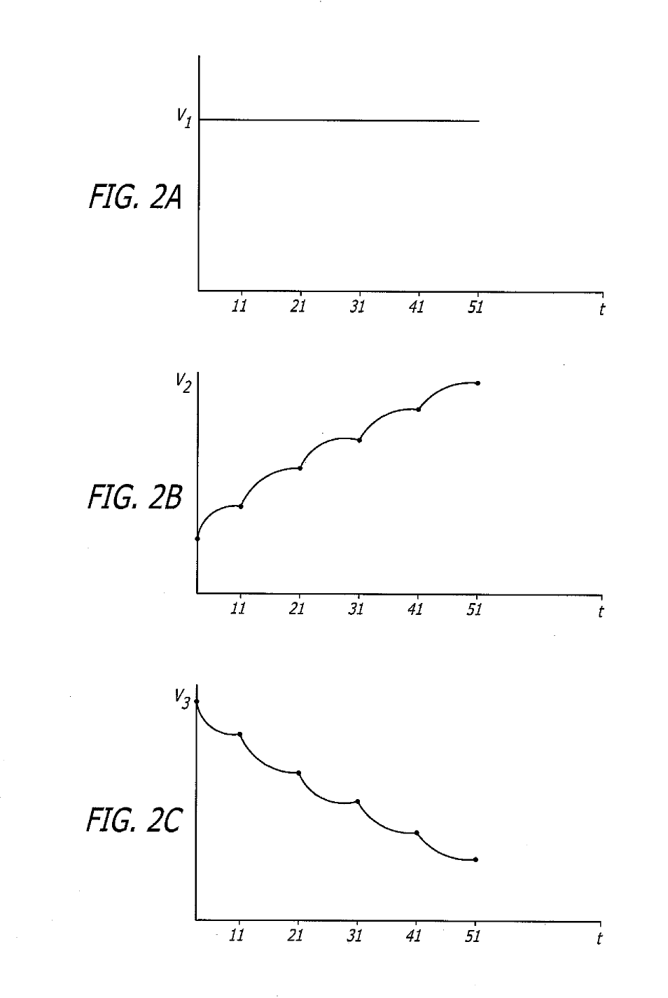

According to exemplary data illustrated in FIGS. 1 and 2, there is shown graphs of the behavior of pressure over time in FIGS. 1A and 1B in chambers C₁ and C₁ and volume over time in chambers C₁, C₂, and C₃ in FIGS. 2A, 2B, and 2C. Accordingly, in FIGS. 1A and 1B, P₁ begins at an initial level. According to an embodiment, P₁>>P₂. Thus, as a conduit between C₁ and C₂ is opened, P₂ increases from some baseline level (bottom of P₂ graph) to a higher pressure level owing to the pressure difference between P₁ and P₂. According to embodiments, when the conduit between P₁ and P₂ is opened, P₁=P₂. According to other embodiments, there is a restrictor disposed in the conduit between P₁ and P₂ reducing flow such that P₂ is never pressurized to the same pressure as P₁, which is desirable both because the useful life of C₁ is extended and relative control of pressure in C₂ provides a degree of control over flow rate.

After the pressure in P₂ is increased, the increased pressure causes fluid to be dispensed. As the fluid is dispensed, the volume of C₂ increases (See FIG. 2B), which in turn gradually reduces the pressure in C₂, as shown in the graph of P₂. According to embodiments, the gradual reduction in pressure may be due to a flow restrictor or the inherent friction in the delivery apparatus.

Because the volume of C₂ and C₃ is a constant, as the volume of C₃ decreases as fluid is dispensed, the volume of C₂ increases. As shown in FIGS. 2A-2C, the volume of C₁ remains constant throughout. However, the volume of C₂ and C₃ are linked. As the pressure in C₂ is increases, fluid is dispensed from C₃ more rapidly. Thus, as shown in the V₂ graph, (FIG. 2B) the rate of volume change is fastest when the pressure within C₂ is highest.

For example, at x-axis value 11, C₂ is pressurized from C₁. Thus, in FIG. 1B the pressure of P₂ increases. At the same time, the rate of volume change in V₂ (FIG. 2B) increases most rapidly. However, the rate gradually decreases until the pressure in C₂ is increased again at x-axis value 21. As will be noted, the volume of V₂ continually increases over time, although the rate of volume increase depends on the pressure within C₂.

Referring still to FIGS. 2A-2C, the volume within C₃ continually decreases as the volume of C₂ increases because the combined volume of C₂ and C₃ is constant. Similar to the behavior with respect to the volume of C₂, the volume of C₃ decreases (i.e., the volume of fluid dispensed) most rapidly when the pressure within C₂ is highest. As the pressure in C₂ decreases due to the increased volume of C₂, the rate of fluid flow gradually decreases. According to embodiments, a flow restrictor may be placed downstream of the fluid flow path to ensure a more uniform flow rate.

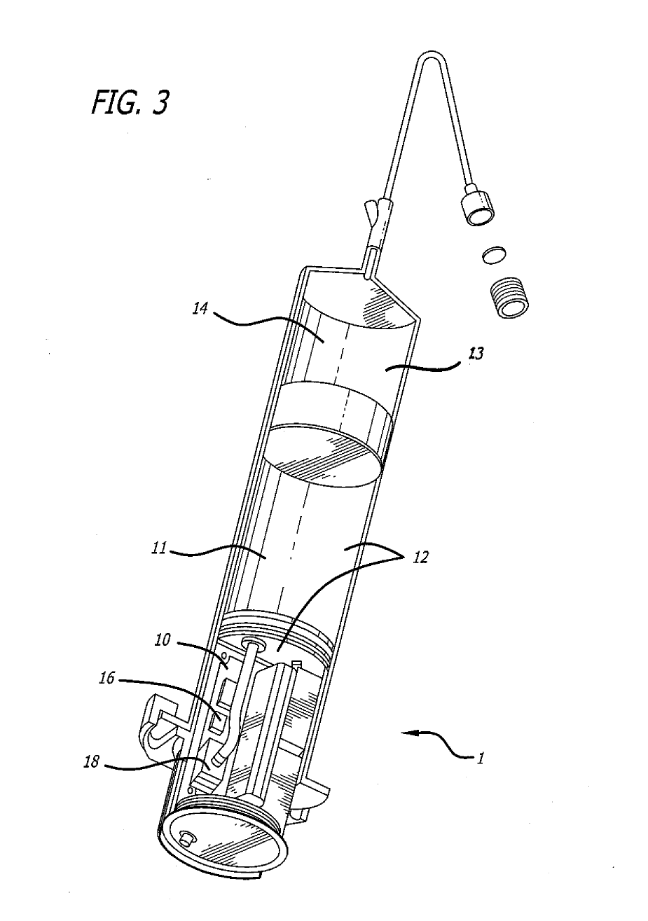

Various embodiments of the present disclosure capture the intended spirit and scope of the principles or methods of the present disclosure. Turning now to an embodiment shown in FIG. 3, the principles disclosed herein are applicable to a syringe-type fluid delivery system. The exemplary device 1 of FIG. 3 comprises three chambers. Artisans will recognize that additional chambers are possible, depending on the configuration.

First chamber (C₁) 10 and second chamber (C₂) 11 hold gas 12. As gas 12 moves between first chamber 10 and second chamber 11, fluid 13 held in sterile third chamber 14 is delivered. Fluid 13 is delivered at a controlled rate as gas 12 in first chamber 10 enters second chamber 11. Two pressure probes 16 and 18 sense the pressure in the chambers 10 and 11, respectively. As previously disclosed, monitoring the pressure of first chamber 10 and second 11 provide data enough to determine the volume of third chamber 14 holding fluid 13 accurately and without the need to make a direct measurement of the volume of fluid dispensed. Consequently, because the flow measurement tools do not contact fluid 13, the devices of the present disclosure are ideal for medical applications. Similarly, once the volume of third chamber 14 is determined, a volume or flow rate may be derived by taking additional measurements over time. Artisan will appreciate that other applications, such as petroleum drilling and pumping, are also possible and improved using the devices and methods of the present disclosure.

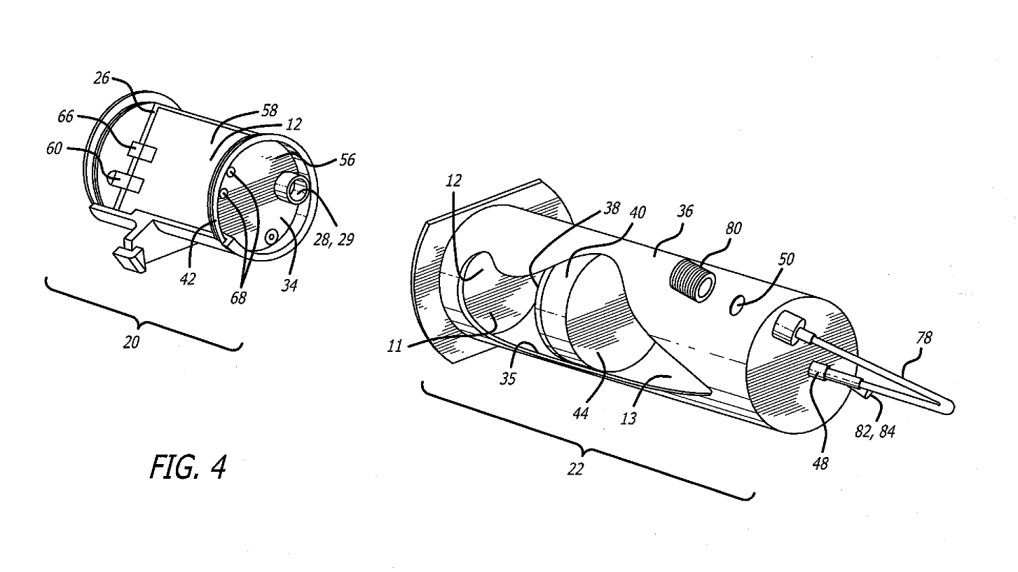

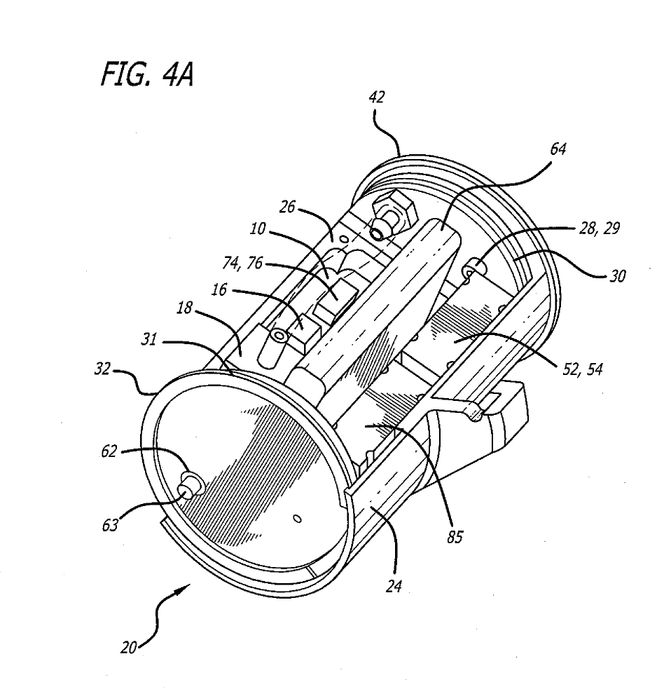

More particularly, according to an embodiment shown in FIG. 4, device 1 (see FIG. 3) comprises hardware module 20 and delivery module 22. According to an embodiment, hardware module 20 is reusable, which is an attractive feature because its components are relatively expensive. Delivery module 22, according to an embodiment, is disposable. This disposability is desirable for the delivery module in applications requiring a sterile environment, such as medical applications.

According to still other embodiments, delivery module 22 is also reusable by allowing a sterile bag or bag-like pouch of fluid 13 to be inserted into device 1 and delivered as described herein.

As particularly shown in FIG. 4A, hardware module 20 and delivery module 22 together define three chambers 10, 11, and 14 corresponding to C₁, C₂, and C₃ respectively. First chamber 10 is defined by the inner surfaces of body 24 and pair of end caps of insert 26 of hardware module 20. According to embodiments, first chamber 10 is filled with the gas 12 such as air, nitrogen, or another gas that can be suitably compressed. According to embodiments, gas 12 is pressurized. First chamber 10 may be charged with gas 12 via fill port 28 containing check valve 29 that is used to prevent unwanted leakage of gas 12 into second chamber 11. Two o-rings 30, 31 are used on the end caps of insert 26 to seal gas 12 inside first chamber 10. Insert 26 is secured onto body 24 through the use of retaining ring 32.

Similarly, first chamber 10 may be a pump chamber, or other similar chamber that may repeatedly inject aliquots of pressured gas into second chamber 11 to increase pressure of second chamber 11 such that fluid 13 is dispensed. In effect, a small chambered first chamber 10 is repeatedly depleted and replaced. Importantly, first chamber 10 would deliver a relatively precise amount of gas at each aliquot whereby n₁₂ may be reasonably assumed.

Second chamber 11 is defined when hardware module 20 is inserted into delivery module 22. The volume of second chamber 11 is defined by face 34 of insert 26, inner wall 35 of device body 36, and outer face 38 of piston 40 located inside and part of delivery module 22. O-ring 42 seals second chamber 11 because the flow rate calculation disclosed herein assumes that the total mass of gas 12 in chambers 10 and 11 (C₁ and C₂, respectively) remains constant.

Third chamber 14 is defined by inner wall 35 of device body 36 and inner face 44 of piston 40. Third chamber 14 is filled with fluid 13, which may be a medication or some other biologically active substance, according to embodiments. Fluid 13 is delivered to the patient via fluid port 48. Flow restrictor 50 is disposed to regulate flow and provide and approximately constant flow rate. Various sizes of flow restrictor 50 may be provided, depending upon the flow rate and pressure range being used. Additionally, flow restrictor may be disposed in various points along fluid flow path to regulate the rate of flow, as would be known to artisans. Optionally and according to an embodiment, a pressure relief valve may be employed instead of flow restrictor 50. The pressure relief valve is designed to crack at a predetermined pressure. In such an embodiment, boluses of medication are dispensed at a measured overall flow rate rather than a continuous flow of fluid.

To control the flow of gas 12 between chambers 10 and 11 (C₁ and C₂, respectively), solenoid valve 52 is attached to bulkhead 54 of the insert 26. According to embodiments, airflow restrictor 56 may be used in conjunction with solenoid valve 52 to control the flow of gas 12. As disclosed herein previously, first chamber 10 is pressurized to a much higher value than is desirable to charge second 11 each time second chamber 11 is recharged with gas 12. Thus, the purpose of airflow restrictor 56 is to permit gas 12 to move from first chamber 10 to second chamber 11 at a controlled rate so that second chamber 11 may be pressurized to a desired level as dictated by the software. If the gas flow is too fast, too much gas 12 will move from first chamber 10 to second chamber 11, causing over-dispensing. Conversely, if the gas flow is too slow, the solenoid must remain open longer, diminishing the battery life, according to embodiments.

Electronic assembly 58 is provided for the purposes of obtaining information from pressure probes 16 and 18, and optional temperature sensors, calculating the amount of fluid 13 delivered, and adjusting the flow rate by controlling the duty cycle of solenoid valve 52. Mode switch 60 is provided to initiate the various sequences controlled by printed circuit board assembly 58. Seal 62 and switch plunger 63 prevent leakage of gas 12 through mode switch 60. Battery 64 provides power to the electrical components inside hardware module 20. LED 66 is provided to indicate when an error condition has occurred. A set of charging contacts 68 are provided for charging the battery between treatments, according to embodiments.

According to an embodiment, pressure probe 16 is used to sense the absolute pressure inside first chamber 10. According to an embodiment, pressure probe 18 senses the absolute pressure inside second chamber 11. According to alternate embodiments, gauge pressure sensors from which the absolute pressure values could be calculated. Similarly, artisans will readily appreciate that a differential pressure sensor may be similarly used to calculate the difference in pressure between chambers C₁ and C₂ after a transfer of gas has occurred.

According to an embodiment, first temperature sensor 74 and second temperature sensor 76 are used to provide the temperature of gas 12 in first chamber 10 and second chamber 11, respectively. Gas 12 temperature is used to more accurately determine the volume of third chamber 14. According to other embodiments, first temperature sensor 74, second temperature sensor 76, or both may be eliminated for applications where the fluid temperature is assumed to be constant, although accuracy may be reduced somewhat.

According to an embodiment, delivery module 22 also incorporates capillary tube 78 and Luer fitting 80 for connection to a patient catheter or IV system (not shown). Liquid fill port 82 and check valve 84 are provided to fill third chamber 14 with fluid 13, according to embodiments. According to other embodiments, delivery module 22, capillary tube 78, Luer fitting 80, and liquid fill port 82 may be substituted or eliminated.

Solenoid vent valve 85 is employed, according to an embodiment, as a failsafe feature for venting all gas 12 from second chamber 11, in the event of a malfunction of solenoid 52, preventing further dispensing of medication when an error state is triggered.

According to an embodiment, delivery module 22 is packaged in a sterile pouch. Fluid 13 may be infused into delivery module 22 by the qualified medical professional or pharmacist through liquid fill port 82. Once filled to the desired volume, delivery module 22 is bagged and labeled for use. Any volume of fluid, up to the capacity of device 1, can be dispensed.

Once delivery module 22 is filled, it is connected to hardware module 20, primed, and connected to the patient. After each use, both battery 64 and first chamber 10 gas 12 pressure are recharged for the subsequent use. The target pressure, is defined as the pressure in second chamber 11 required to produce the required fluid flow rate for a given size of the flow restrictor 50. Initially, the pressure in first chamber 10 is sufficiently high such that when piston 40 reaches the end of its stroke, the pressure in first chamber 10 remains greater than the target pressure.

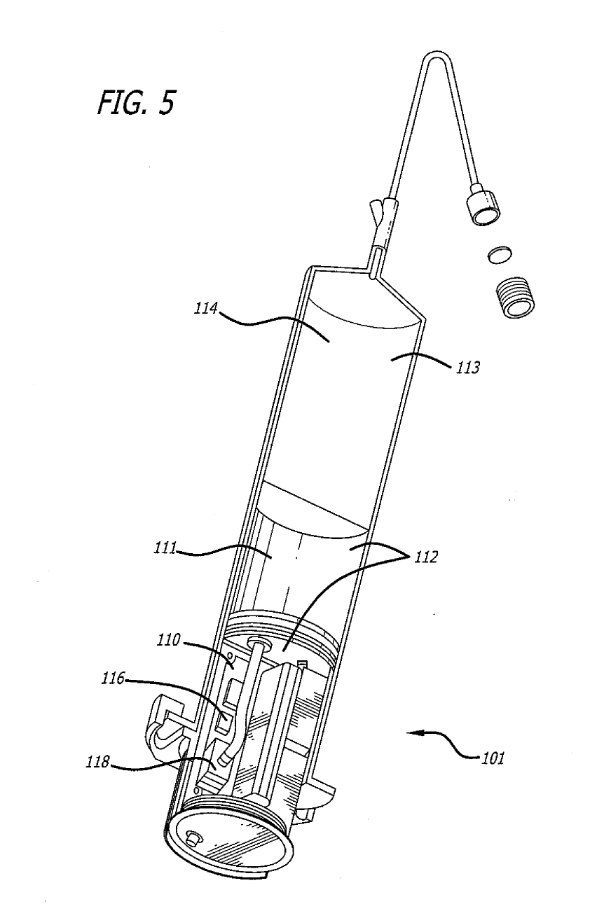

Artisans will recognize the methods or principles of the present disclosure are applicable to variations on the themes shown in FIGS. 3, 4, and 4A. As shown according to an embodiment illustrated in FIG. 5, device 101 may comprise two chambers, first chamber (C₁) 110 and second chamber (C₂) 111. First chamber 110 and second chamber 111 hold gas 112. Third chamber (C₃) 114 comprises a removable sterile chamber holding fluid 113, for example, a sterile bag or bag-like container than is compressible. According to this embodiment, rather than a piston to drive fluid from third chamber 114, as pressure is increased in second chamber 111, the pressure in second chamber 111 eventually exceeds the pressure in third chamber 114 which effects flow of fluid from third chamber 114. Artisans will readily observe that the compressible walls of third chamber 114 are an equivalent of the piston of FIGS. 3, 4, and 4A.

According to embodiments, device 101 is modular as shown in FIGS. 3, 4, and 4a, for example, where third chamber 114 is inserted into device 101 where hardware module 20 and delivery module 22 (FIG. 4) come apart. According to alternate embodiments, a sealable opening within the body of device opening into second chamber 111 may be provided, such as a door. The sealable opening provides a conduit whereby removable third chamber 114 may be insert into device 101 and connected for delivery of fluid 113. The opening must be sealable to prevent appreciable leak of gas 112 as the pressure of second chamber 111 is increased.

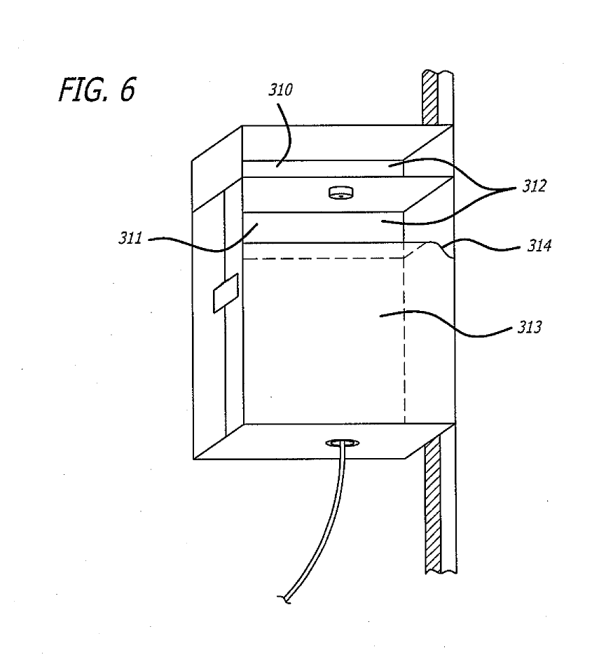

According to still another embodiment, the principles of the present disclosure have equivalents in intravenous (IV)-type fluid delivery systems. Like a syringe-type device and as illustrated in FIG. 6, an IV-type fluid delivery system may have multiple chambers and operate by the methods or principles disclosed herein.

According to an embodiment illustrated in FIG. 6, first chamber 310 may be pressurized with gas 312. First chamber may be a large, fixed volume chamber wherein the pressure in first chamber 310 is much greater than the pressure of second chamber 311. Alternately, first chamber may comprise a pump-type mechanism wherein first chamber 310 comprises a small chamber by comparison to the size of second chamber 311 and wherein multiple aliquots of gas 312 are injected into second chamber 311 in a single pressurizing interval or frequently over time to ensure the pressure in second chamber 311 remains above a predetermined level necessary to dispense fluid 313.

According to the exemplary embodiment, second chamber 311 comprises an openable sealable chamber, as is common in the art, for instance a sealable door and latch system. Third chamber 314, which according to embodiments may comprise a compressible IV-bag or an equivalent, is inserted into second chamber 311. Second chamber 311 is closed thereby sealing second chamber 311 from external exchange of gas, such as air.

Pressurized gas 312 in first chamber 310 is transferred into second chamber 311 as disclosed herein to increase the pressure in second chamber 311. Optionally, as described, gas 312 in second chamber 311 is purged prior to receiving pressurized gas from first chamber 310 in an initialization operation. As in each of the other embodiments described herein, as the pressure in second chamber 311 increases, fluid 313 is dispensed from third chamber 314. A flow restrictor may be disposed along the flow path to provide a relatively constant flow rate.

Temperature sensors may be disposed in any of the embodiments or equivalents to improve the accuracy of the determination of the volumes of C₂ and C₃, that is V₂ and V₃, respectively.

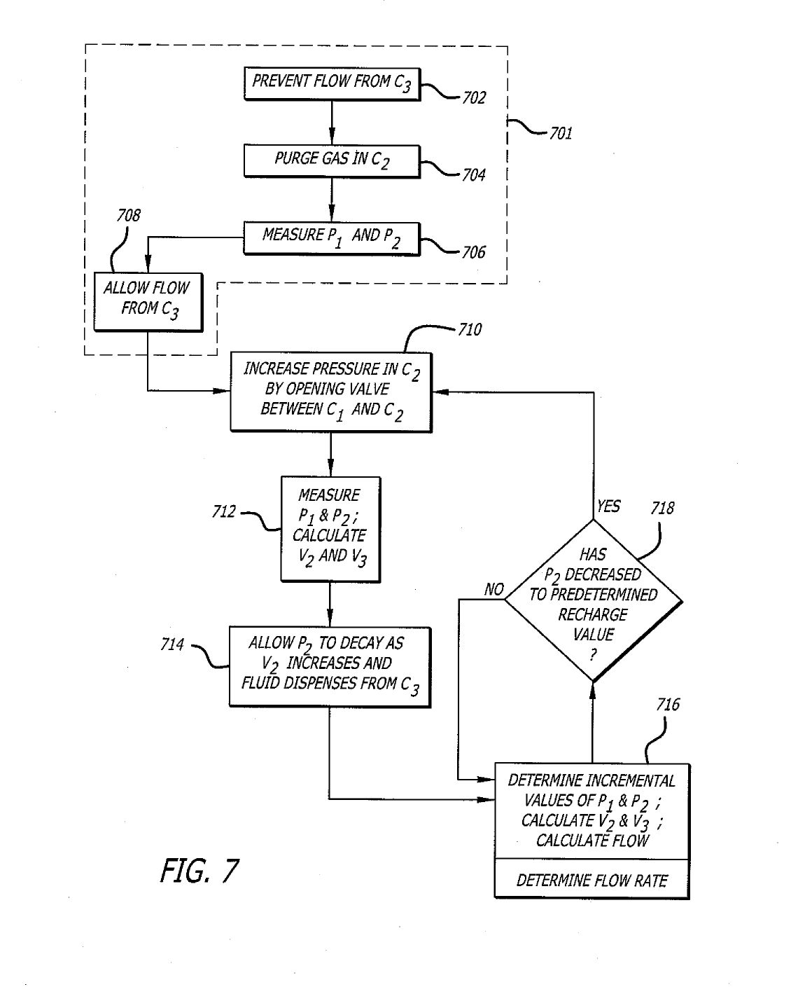

An embodiment of a method for operating the devices of the present disclosure is illustrated in FIG. 7. Initially, an initialization operations 701 is performed to provide a large ΔP value for C₂. As previously disclosed, the large ΔP value improves accuracy of the measurement of V₂. To initialize, flow of fluid is prevented from C₃ in operation 702. Thereafter, gas is purged from C2 in operation 704, and the pressure sensors measure P₁ and P₂ in operation 706. The pressure values measured in the initialization are used as the initial values for all subsequent volume calculations, according to embodiments. After the initialization pressure values P₁ and P₂ are determined, flow of fluid is permitted from C₃ and normal operation commences in operation 708. According to embodiments, initialization operation 701 may be omitted together with the associated reference calculations.

Pressure is increased in C2 such that P₂>P₃ to induce fluid flow from C₃ in operation 710. Thus P₂ is increased in C₂ by opening a valve between C₁ and C₂, according to an embodiment. P₂ is increased to a predetermined level and the valve between C₂ and C₃ is closed. P₁ and P₂ are again determined in operation 712. From the pressure measurements made in both operation 706 and operation 712, V₂ and V₃ are calculated as disclosed herein.

As the volume of C₂ increases as fluid is dispensed from C₃, P₂ decays in operation 714. As previously disclosed, the rate of flow from C₃ decreases as P₂ decreases. Incremental pressure measurements of P₁ and P₂ are obtained from the pressure sensors in operation 716. When P₂ has decreased to a predetermined level in operation 718, operation 710 is repeated whereby the pressure of C₂ is recharged. Otherwise, additional incremental pressure measurements of P₁ and P₂ are obtained in operation 716 until P₂ has decreased to the predetermined recharge value.

At each incremental pressure measurement, the flow rate of fluid being dispensed from C₃ is determined in operation 716. According to an embodiment, flow rate may be calculated based on the current and historical incremental measurements of P₁ and P₂ by calculating before and after volumes of C₃ using the initially recorded pressure values and the values at each measurement interval and subtracting the difference to get an over all ΔV₃, which when divided by the time interval gives the flow rate. These values provide data on the real-time changes in flow rate. According to another embodiment, overall flow rate may be determined by using the current incremental measurements of P₁ and P₂ and the initial measurement of P₁ and P₂ determined in operation 706. Total volume delivered and flow rate may also be similarly calculated by using initial pressure measurements and current pressure measurement to determine the total amount of fluid delivered and, consequently, the total flow rate. Artisans will readily recognize that these measurements may be useful in the same application to determine a real-time flow rate as well as total flow rate over time or a determination of the total amount of a substance delivered according to the methods of the present disclosure.

The ability to accurately determine flow rate of the fluid being delivered may be used as a safety mechanism as well. For example, if flow rate diminishes greatly over a short period of time in a drug delivery-type application of the devices and methods of the present disclosure, an occlusion may have developed and flow of the fluid may be shut off by immediately venting C₂, according to an embodiment. Similarly, according to an embodiment, if the flow rate is greatly increased over a short period of time in drug delivery-type applications, it may be an indication that a catheter inserted into a vein has become dislodged and C₂ may be immediately vented to stop further flow. Artisans will recognize the various other applications whereby information imparted by knowing the flow rate in about real time is useful to predict problems or provide increased safety with the devices and methods of the present disclosure.

As an added safety feature, according to embodiments, the methods of the present disclosure will be aborted at any point wherein an error is detected. Error states include, according to embodiments, if a clock/time measurement error occurs or the pressure in C₂ rises above a predetermined maximum or minimum value. According to embodiments, when an error state is determined, C₂ is purged to prevent any further flow of fluid from C₃. Also according to embodiments, an indicator, such as an LED or noise alert, may be activated to alert users of the error state.

According to embodiments, when the volume of C₂ or C₃ reaches a predetermined value, users will be alerted that no additional fluid remains to be dispensed or that very little fluid remains to be dispensed. Notification may be effected by an LED or noise alert, according to embodiments.

Temperature determination may be done in parallel with the determination of pressure, according to embodiments. Suitable temperature sensors 806 may be deployed in C₁ and C₂ to improve the accuracy of the calculation of the volumes of V₂ and V₃ in C₂ and C₃, respectively. Temperature sensors 806 thereby provide additional operations that are done at the same time pressure determination is done.

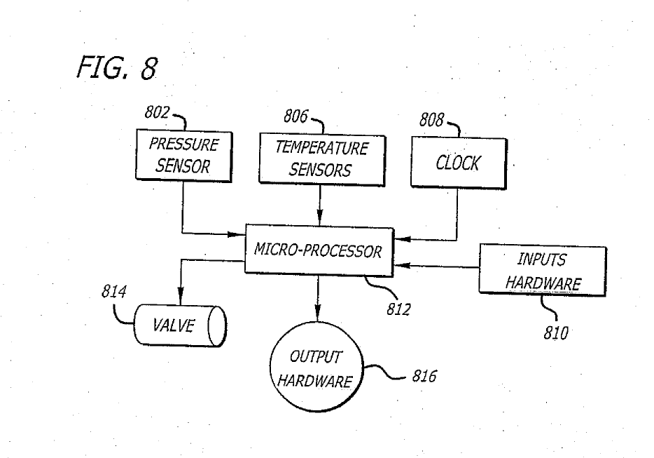

According to an embodiment illustrated by FIG. 8, there is shown a block diagram of an embodiment of an electronic assembly for controlling the devices and methods disclosed herein. Pressure sensors 802 are connected to microprocessor 812 having software capable of performing the calculations herein and interfacing with the various components of the system. According to embodiments, temperature sensor 806 may likewise connect to microprocessor 812 to provide temperature readings for both C₁ and C₂. According to embodiments, a third temperature sensor may be disposed in C₃ as well. Clock 808 provides time measurements to microprocessor 812 to allow for calculation of flow rate, etc. According to embodiments, microprocessor 812 controls the valves of the devices disclosed herein and their equivalents, as well as the output hardware 816, such as LEDs and sound generating devices. Input hardware 810 also connects to microprocessor 812 and allows various input commands, such as power on, initialize, etc.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A device comprising:
at least one first chamber;
at least one second chamber, each second chamber having a pressure sensor to measure pressure in each second chamber;
at least one third chamber having a dispensing port;
a device controlling the flow of gas from the first chamber to the second chamber;
a movable boundary between the second chamber and the third chamber; and
a processor.

2. The device of claim 1, wherein each first chamber having a pressure sensor to measure pressure in each first chamber.

3. The device of claim 1, further comprising:
a temperature sensor disposed in each first chamber and each second chamber.

4. The device of claim 1, wherein the volume of each first chamber is fixed.

5. The device of claim 1, wherein the volume of the second and third chambers is fixed.

6. The device of claim 5, wherein the volume of the third chamber is calculated by subtracting a total volume of the second chamber and the third chamber from the volume of the second chamber.

7. The device of claim 6, wherein the volume of the second chamber is determined by measuring pressure change in the second chamber and each first chamber before gas is moved from the first chamber into the second chamber and after gas is moved from the first chamber into the second chamber; and
wherein the determination is accomplished using the ideal gas law.

8. The device of claim 1, wherein the device for transferring gas is a solenoid valve.

9. The device of claim 1, wherein the device for transferring gas comprises at least a restrictor.

10. The device of claim 1, wherein the movable boundary between the second and the third chamber is a piston.

11. The device of claim 1, wherein the movable boundary between the second chamber and the third chamber is a well of a flexible vessel holding a fluid to be delivered.

12. The device of claim 1, wherein the third chamber comprises one a flexible container holding a fluid.

13. The device of claim 1, wherein one or more first chambers comprise the chambers of a pump.

14. A method comprising:
providing at least one first chamber holding a gas;
providing at least one second chamber holding a gas;
providing at least one third chamber holding a fluid to be delivered;
determining a first pressure in each first chamber;
determining a first pressure in each second chamber;
transferring gas from at least one first chamber to at least one second chamber to determine the volume of a second chamber;
determining a second pressure in each first chamber;
determining a second pressure in each second chamber; and
calculating the dispensed volume of fluid from the third chamber based upon the determined first pressures and second pressures.

15. The method of claim 14, wherein the pressure of the gas in at least one first chamber is greater than the pressure of the gas in the second chamber that gas in the first chamber is transferred to.

16. The method of claim 15, wherein the pressure of the gas in the at least one first chamber is substantially greater than the pressure of the gas in the second chamber, wherein multiple aliquot of gas may be transferred from the first chamber into the second chamber resulting in the pressure of the first chamber remaining greater than the pressure of the second chamber.

17. The method of claim 14, further comprising initializing, wherein initializing further comprises:
preventing flow of the fluid to be delivered;
purging a portion of the gas from the second chamber;
determining a first initial pressure in each first chamber;
determining a first initial pressure in each second chamber; and
transferring gas from at least one first chamber to at least one second chamber.

18. The method of claim 17, wherein the initializing further comprises:
determining a second initial pressure in each first chamber after the gas has been transferred;
determining a second initial pressure in each second chamber after the gas has been transferred; and
calculating an initial volume of each second chamber.

19. The method of claim 17, wherein the initializing further comprises:
allowing the flow of the fluid to be delivered after each second initial pressure in each first chamber and in each second chamber has been measured.

20. A method comprising:
calculating the pressure difference in a first chamber and a second chamber after a gas has been transferred to calculate the volume of a third chamber by
a) determining the volume of the first chamber and the total volume of the second and third chambers.
b) determining the pressures of both the first chamber and second chamber prior to transfer of the gas from the first chamber to the second chamber;
c) transferring an aliquot of gas from the first chamber to the second chamber; and
d) determining the pressures of both the first chamber and the second chamber after the gas is transferred;
calculating the volume of the second chamber from the pressure data collected prior to the transfer of gas and the pressure data after the transfer of the gas using the ideal gas law;
calculating the volume of the third chamber by subtracting the volume of the second chamber from the total volume of the second and third chambers to determine the volume of fluid delivered.

21. The method of claim 20, further comprising including temperature measurements in the calculation of the volume of the second chamber by disposing temperature sensors in the first and second chambers and measuring temperature at the same time each pressure measurement is determined.
